(19) United States
(12) Patent Application Publication
(10) Pub. No.: US 2008/0209272 A1
(43) Pub. Date: Aug. 28, 2008

(54) Apparatus and Method For Sensing Faults of Application Programs in a Cdma System

(75) Inventor: Ki Sung Lyu, Chungcheongbuk-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Korea Limited, Kyongki-do (KR)

(21) Appl. No.: 10/586,289

(22) PCT Filed: Jan. 14, 2005
(86) PCT No.: PCT/KR05/00139

§ 371 Date: May 5, 2008

(30) Foreign Application Priority Data
Jan. 15, 2004 (KR) 10-2004-0002980

(51) Int. Cl. G06F 11/07

(52) U.S. Cl. 714/37; 714/E11.025

(57) ABSTRACT

The present invention generally relates to apparatus and method for sensing faults of application programs in a CDMA system, which comprises a shared memory comprising a plurality of fields, wherein each of the fields comprises a Heart Beat; a plurality of application programs corresponding to the plurality of fields in the shared memory on a one-to-one basis, each of which accesses to the corresponding field and increments the corresponding Heart Beat by 1 when a certain period (p1) elapses; and an operation and management processing unit which detects values of the Heart Beats of the plurality of fields in the shared memory when other certain period (p2) elapses, if all of the values of the Heart Beats equal “1,” then the operation and management processing unit initializes the values to “0” and performs normal operation, and if any of the values of the Heart Beats equals to “0,” then the operation and management processing unit recognizes a fault of an application program connected to the field, the value of Heart Beat which is “0,” and issues an alarm. According to the apparatus and method for sensing faults of application programs in a CDMA system of the present invention, the procedure of monitoring application programs can be simplified. This improves the efficiency of the system, compared to the conventional method, which executes the system commands repeatedly and monitors the operation status by detecting the returned value.

### TECHNICAL FIELD

The present invention generally relates to an apparatus and method for sensing faults of application programs in a CDMA system, and more particularly to an apparatus and method for sensing faults of application programs in a CDMA system to sense faults of application programs, which provide uninterrupted service, and manage them in real time.

### BACKGROUND ART

In order to detect the operation status of processors, apparatuses for managing application programs in a conventional CDMA system executes system commands, analyzes the returned results and determines the status. In other words, in order to monitor the operation status of application programs, an operation management processor executes several system commands, summarizes the results of the executions and finally determines the status.

However, the conventional procedure for monitoring the application programs has to repeatedly execute several different system commands, which have different parameters for every application program. Therefore, the conventional procedure has problems in that the management procedure is quite complicated and the efficiency of the system becomes degraded.

Furthermore, the conventional procedure for monitoring the application programs collects the information of application programs by executing system commands. Therefore, the completion of execution of system commands becomes delayed. Thus, the conventional procedure has problems in that it cannot sense the faults of application programs quickly since it has to prolong the monitoring period in order to reduce the system loads.

### DISCLOSURE OF THE INVENTION

It is an object of the present invention to provide an apparatus for sensing faults of application programs in a CDMA system. In accordance with the present invention, the procedure of monitoring faults of application programs may be simplified by monitoring the operation status of application programs, and the sensing speed may be improved by reducing the monitoring period.

To accomplish the above object, an apparatus for sensing faults of application programs in a CDMA system, in accordance with the present invention, comprises:

a shared memory comprising a plurality of fields, wherein each of the fields comprises a Heart Beat;

a plurality of application programs corresponding to the plurality of fields in the shared memory on a one-to-one basis, each of which accesses to the corresponding field and increments the corresponding Heart Beat by 1 when a certain period (p1) elapses; and

an operation and management processing unit which detects values of the Heart Beats of the plurality of fields in the shared memory when other certain period (p2) elapses, if all of the values of the Heart Beats equal to “1,” then the operation and management processing unit initializes the values to “0” and performs normal operation, and if any of the values of the Heart Beats equals to “0,” then the operation and management processing unit recognizes a fault of an application program connected to the field, the value of Heart Beat of which is “0,” and issues an alarm.

Furthermore, there is provided a method for sensing faults of application programs in a CDMA system, which is in accordance with the present invention. The method of the present invention senses the faults of a plurality of application programs, each of which performs a unique operation in the CDMA system. The method comprises:

A method for sensing faults of a plurality of application programs in a CDMA system, each of the application programs performing a characteristic operation, the method comprising:

a first step wherein an operation and management processing unit generates a shared memory, the shared memory comprising a plurality of fields, wherein each of the fields comprises a Heart Beat, wherein the plurality of fields correspond to the plurality of application programs on a one-to-one basis;

a second step wherein the operation and management processing unit detects whether the present time is a reading period (p2) of the Heart Beat;

a third step wherein if the present time is not the reading period (p2) of the Heart Beat, then the second step is performed again, and if the present time is the reading period (p2) of the Heart Beat, then the operation and management processing unit reads all of the values of the Heart Beat in the plurality of fields of the shared memory;

a fourth step wherein the operation and management processing unit determines whether any of values of Heart Beats in the plurality of the fields equals to “0”;

a fifth step wherein if there is no field, the value of Heart Beat which equals to “0”, i.e. the values of Heart Beats in all fields equal to “1”, then the operation and management processing unit initialize all values of Heart Beats to “0” and the second step is performed again;

a sixth step wherein if there is a field, the value of Heart Beat which equals to “0”, among the plurality of fields, then the operation and management processing unit detects a fault of application program corresponding to the field and issues an alarm; and

a seventh step wherein the second step is performed again after the operation and management processing unit initializes all values of the fields except the field in which the fault is detected.

### BRIEF DESCRIPTION OF DRAWINGS

FIG. 1 illustrates a block diagram of the apparatus for sensing faults of application programs in a CDMA system according to one embodiment of the present invention.

FIG. 2 illustrates a flow chart of the method for sensing faults of application programs in a CDMA system according to one embodiment of the present invention.

### BEST MODE FOR CARRYING OUT THE INVENTION

Now, the present invention entitled “Apparatus and Method for Sensing Faults of Application Programs in a CDMA system” will be described referring to the accompanying drawings.

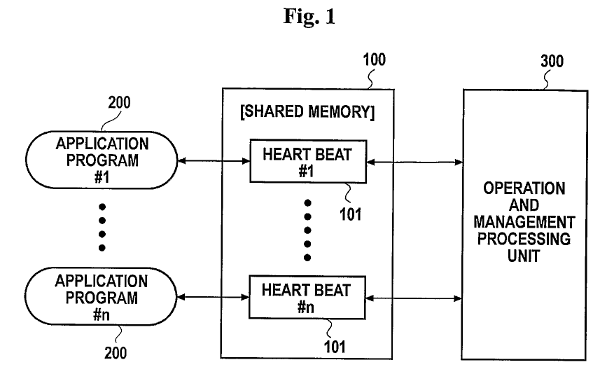

FIG. 1 illustrates a block diagram of the apparatus for sensing faults of application programs in a CDMA system according to one embodiment of present invention. The apparatus for sensing faults of application programs in a CDMA system according to one embodiment of the present invention comprises shared memory 100, a plurality of application programs 200, and operation and management processing unit 300.

Each shared memory 100 comprises a plurality of fields having a Heart Beat.

Furthermore, a plurality of application programs 200, which are programs that perform characteristic operations in a CDMA system, correspond to a plurality of fields 101 in shared memory 100 on a one-to-one basis. When a certain period p1 elapses, each of the plurality of application programs 200 accesses to the corresponding field 101 and increments the corresponding Heart Beat by 1.

When another certain period p2 elapses, operation and management processing unit 300 detects the values of Heart Beats of a plurality of fields 101 in shared memory 100. If all of the values of the Heart Beats equal to “1”, then the operation and management processing unit initializes the values to “0” and performs normal operation. In contrast, if any of the values of the Heart Beats equals to “0”, then the operation and management processing unit recognizes a fault of an application program connected to the field and issues an alarm.

In this regard, attaching period p1 of the Heart Beat of the application program 200 and reading period p2 of the Heart Beat of the operation and management processing unit 300 satisfy the following condition in length:

p1<p2 Equation 1

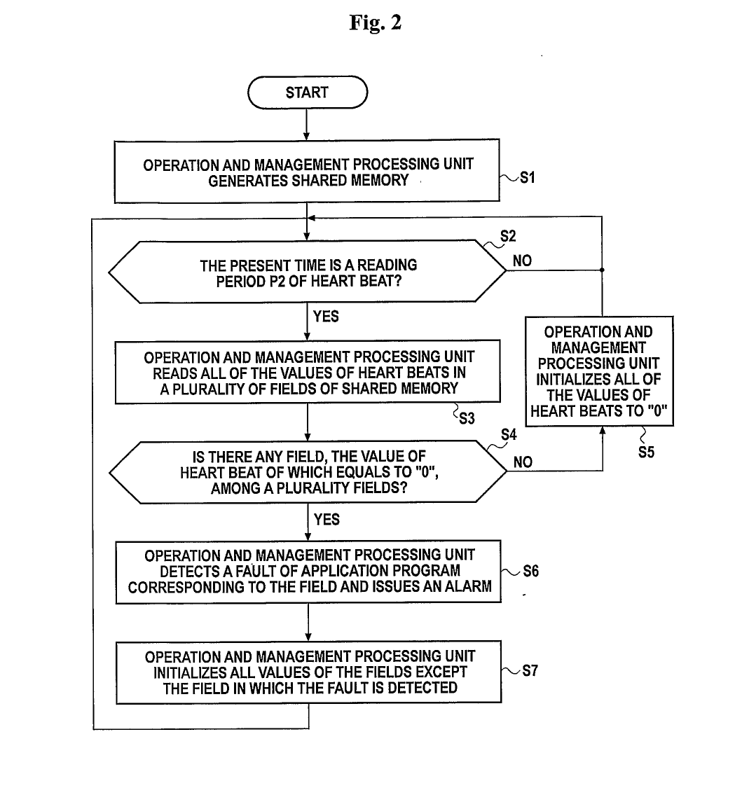

The method for sensing faults of application programs in a CDMA system using the apparatus as described above will now be described referring to FIG. 2.

First, operation and management processing unit 300 generates a shared memory connected to a plurality of application programs 200 (S1). Shared memory 100 comprises a plurality of fields 101, each of which comprises a Heart Beat, and a plurality of fields 101 are connected to a plurality of application programs 200 on a one-to-one basis.

Then, the operation and management processing unit detects whether the present time is a reading period p2 of the Heart Beat (S2).

In the second step (S2), if the present time is not the reading period p2 of the Heart Beat (NO), then the second step is performed again. In contrast, if the present time is a reading period p2 of the Heart Beat (YES), then the operation and management processing unit 300 reads all of the values of the Heart Beats in the plurality of fields of shared memory 100 (S3).

Then, the operation and management processing unit 300 determines whether any of the values of Heart Beats in a plurality of fields 101 equals to “0” (S4).

In the fourth step (S4), if there is no field 101, the value of Heart Beat which equals to “0”, i.e. the values of Heart Beats in all fields 101 equals to “1”, then the operation and management processing unit 300 initialize all values of Heart Beats to “0”, and the method proceeds to the second step (S2) again.

In contrast, in the fourth step (S4), if there is any field, the value of Heart Beat which equals to “0”, among the plurality of fields 101 (YES), then the operation and management processing unit 300 detects a fault of application program 200 corresponding to the field 101 and issues an alarm (S6).

Then, the operation and management processing unit 300 initializes all values of the fields except field 101 in which the fault is detected and the method proceeds to the second step again (S7).

Although the specific embodiment of the present invention is described, the present invention is not to be specifically limited to the above embodiment, and has many variations without departing from the scope of the present invention.

### INDUSTRIAL APPLICABILITY

As described above, according to the apparatus and method for sensing faults of application programs in a CDMA system of the present invention, the procedure of monitoring application programs can be simplified, thereby improving the efficiency of the system when compared to the conventional method, which executes the system commands repeatedly and monitors the operation status by detecting the returned value.

In addition, the present invention can detect faults of the application programs more quickly when compared to the conventional method.

1. An apparatus for sensing faults of application programs in a CDMA system, the apparatus comprising:
a shared memory comprising a plurality of fields, wherein each of the fields comprises a Heart Beat;
a plurality of application programs corresponding to the plurality of fields in the shared memory on a one-to-one basis, each of which accesses to the corresponding field and increments the corresponding Heart Beat by 1 when a certain period (p1) elapses; and
an operation and management processing unit which detects values of the Heart beats of the plurality of fields in the shared memory when other certain period (p2) elapses, if all of the values of the Heart Beats equals to “1,” then the operation and management processing unit initializes the values to “0” and performs normal operation, and if any of the values of the Heart Beats equals to “0,” then the operation and management processing unit recognizes a fault of an application program connected to the field, the value of Heart Beat which is “0,” and issues an alarm.

2. The apparatus according to claim 1, wherein the reading period (p2) of the Heart beat of the operation and management processing unit is set up to more than the attaching period (p1) of the Heart beat of the application program.

3. A method for sensing faults of a plurality of application programs in a CDMA system, each of the application programs performing a characteristic operation, the method comprising:
a first step wherein an operation and management processing unit generates a shared memory, the shared memory comprising a plurality of fields, wherein each of the fields comprises a Heart Beat, and wherein the plurality of fields correspond to the plurality of application programs on a one-to-one basis;
a second step wherein the operation and management processing unit detects whether the present time is a reading period (p2) of the Heart Beat;
a third step wherein if the present time is not the reading period (p2) of the Heart Beat, then the second step is performed again, and if the present time is the reading period (p2) of the Heart Beat, then the operation and management processing unit reads all of the values of the Heart Beat in the plurality of fields of the shared memory;
a fourth step wherein the operation and management processing unit determines whether any of values of Heart Beats in the plurality of the fields equals to “0”;
a fifth step wherein if there is no field, the value of Heart Beat which equals to “0”, i.e. the values of Heart Beats in all fields equal to “1”, then the operation and management processing unit initializes all values of Heart Beats to “0” and the second step is performed again;
a sixth step wherein if there is a field, the value of Heart Beat which equals to “0”, among the plurality of fields, then the operation and management processing unit detects a fault of application program corresponding to the field and issues an alarm; and
a seventh step wherein the second step is performed again after the operation and management processing unit initializes all values of the fields except the field in which the fault is detected.
